(19) United States
(12) Patent Application Publication
(10) Pub. No.: US 2019/0385496 A1
(43) Pub. Date: Dec. 19, 2019

(54) DISPLAY PANEL DRIVING METHOD WITH REAL-TIME SENSE AND DISPLAY DEVICE THEREOF

(71) Applicant: Shenzhen china Star Optoelectronics Semiconductor Display Technology Co., Ltd., Shenzhen, Guangdong (CN)

(72) Inventor: Yufeng JIN, Shenzhen, Guangdong (CN)

(21) Appl. No.: 15/736,715

(22) PCT Filed: Nov. 23, 2017
(86) PCT No.: PCT/CN2017/112473

§ 371 Date: Dec. 14, 2017

(30) Foreign Application Priority Data
Sep. 19, 2017 (CN) 201710848749.5

(51) Int. Cl. G09G 3/00; G09G 3/3225

(52) U.S. Cl. CPC G09G 3/006; G09G 2310/061; G09G 2330/12; G09G 3/3225

(57) ABSTRACT

The disclosure provides a display panel driving method with real-time sense and a display device thereof. The display panel driving method includes: increasing a frame rate of display data in the display panel to obtain cyclic frames of the display data; taking any one among the cyclic frames as a sense data frame; and performing a smoothing transition process on adjacent two sense data frames. The disclosure improves the resolution of the display panel and increases the time for sensing to lower the requirement of sensing so as to achieve timely and accurate effect of sensing. Besides, by the post-sensing smoothing algorithm, the black screens due to the sensing are reduced.

### RELATED APPLICATIONS

The present application is a National Phase of International Application Number PCT/CN2017/112473, filed Nov. 23, 2017, and claims the priority of China Application 201710848749.5 filed Sep. 19, 2017.

### FIELD OF THE DISCLOSURE

The disclosure relates to display, and more particularly to a display panel driving method with real-time sense and display device thereof.

### BACKGROUND

With the development of the OLED panel, people have higher and higher demand on the quality of the panel. Compared with other display panels, the OLED has higher gamut, higher contrast ratio, and shorter response time, so the users prefer the OLED display panel. Meanwhile, the OLED has many defects such as the uneven driving TFT characteristic, the black screen, and the screen stuck and external sense for compensating the display panel is necessary. The term sense means “real-time detection” if there is no additional explanation.

There are many sense methods, but different compensation means has different requirement for sensing. There are two compensation mechanisms such as booting sense and real-time sense. The requirement for sensing is low in the booting sense mechanism, but the display effect is getting worse and getting unrecoverable when the panel is used for a long time. In the real-time sense mechanism, it is sensitive to time. Conventionally, the sense is performed during the blank period of each frame, and the blank period is short due to the resolution of the panel. Generally, the conventional display panel has a frame rate of display data such as 60 Hz and the display time for each data frame is 16.7 miniseconds (ms). The blank period in each frame is 0.67 ms. Because the sense is performed in the blank period of each frame, the time for sensing is 0.67 ms and the time is limited by the resolution of the panel. The requirement of real-time sense cannot be satisfied if the display panel has high resolution.

### SUMMARY

The technical problem mainly solved in the disclosure is to provide a display panel driving method with real-time sense and the display device thereof which satisfies the requirement of the real-time sense regardless the timing constraint.

For solving the aforementioned problem, the disclosure provides a display panel driving method with real-time sense, and the method comprises:

increasing a frame rate of display data in the display panel to obtain cyclic frames of the display data;

taking any one among the cyclic frames as a sense data frame, wherein there is at least one non-sense data frame between adjacent two sense data frames; and

performing a smoothing transition process on the adjacent two sense data frames with an image smoothing algorithm.

For solving the aforementioned problem, the disclosure further provides a display panel driving method with real-time sense, and the method comprises:

increasing a frame rate of display data in the display panel to obtain cyclic frames of the display data; taking any one among the cyclic frames as a sense data frame; and performing a smoothing transition process on adjacent two sense data frames.

For solving the aforementioned problem, the disclosure further provides a display device, wherein the display device comprises a display panel and a driving unit, and the driving unit implements the following driving method for real-time sense: increasing a frame rate of display data in the display panel to obtain cyclic frames of the display data; taking any one among the cyclic frames as a sense data frame; and performing a smoothing transition process on adjacent two sense data frames.

Distinguished from the conventional technique, the disclosure provides a display panel driving method with real-time sense different from the conventional sense method by increasing the frame rate of the display data in the display panel so as to obtain the cyclic frames of the display data. Then, one among the cyclic frames is selected as the sense data frame, so the higher resolution is supported and the time for sensing data is delayed. The disclosure increases the time for sensing and lower the requirement of sensing while keeping the timely and accurate sensing effect. Besides, by the post-sensing smoothing algorithm, the black screens due to the sensing are reduced.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a flowchart of a display panel driving method with real-time sense in one embodiment of the disclosure;

FIG. 2 is a schematic diagram of the display panel driving method with real-time sense in one embodiment of the disclosure;

FIG. 3 is a schematic diagram of the display panel driving method with real-time sense in another embodiment of the disclosure; and

FIG. 4 is a schematic diagram of the display panel driving method with real-time sense in yet another embodiment of the disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”, “transverse”, “above”, “below”, “left”, “right”, “vertical”, “horizontal”, “top”, “bottom”, “inside”, “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

In the description of the disclosure, is should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

The disclosure will be further described in detail with reference to accompanying drawings and preferred embodiments as follows.

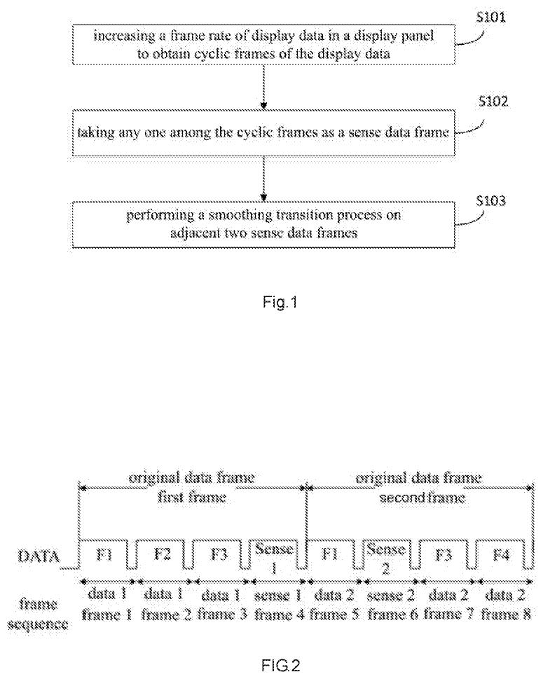

Please refer to FIG. 1, which is a flowchart of a display panel driving method with real-time sense in one embodiment of the disclosure. The display panel driving method with real-time sense includes:

S101: increasing the frame rate of the display data in the display panel so as to obtain the cyclic frames of the display data.

Practically, taking OLED display panel for example, on the basis of the original frame rate of the display data of the OLED display panel, the frame rate of the display data in the display panel is increased based on the design requirement and the cyclic frames of the display data are obtained. For example, when the frame rate of the display data of the OLED display panel is increased by M times, M cyclic frames of the display data are obtained. In one embodiment, if the frame rate of the display data of the OLED display panel is increased by 4 times, four cyclic frames of the display data are obtained. That is, each data frame is repeatedly displayed for four times and the display time for each frame of data is 4.17 ms while one data frame is originally displayed once and the display time for each frame of data is 16.7 ms. In another embodiment, if the frame rate of the display data of the OLED display panel is increased by 8 times, eight cyclic frames of the display data are obtained. That is, each data frame is repeatedly displayed for eight times and the display time for each frame of data is 2.08 ms while one data frame is originally displayed once and the display time for each frame of data is 16.7 ms. Practically, the value of M may be determined based on the required time for sense and it is not limited thereto.

S102: taking any one among the cyclic frames as a sense data frame.

After the frame rate of the display data in the display panel is increased and the cyclic frames of the display data are obtained, one among the cyclic frames is selected arbitrarily as the sense data frame. That is, for each display data, one sense data frame is selected from its cyclic frames. Especially, for preventing the display data from the distortion, there is at least one non-sense data frame between the adjacent two sense data frames. In one embodiment, there is one non-sense data frame between the adjacent two sense data frames. In another embodiment, there are at least two non-sense data frames between the adjacent two sense data frames, and the at least two non-sense data frames are in the adjacent display data. In yet another embodiment, there are at least two non-sense data frames between the adjacent two sense data frames, and the at least two non-sense data frames are in the same display data. In advance, the relationship between the positions of the adjacent two sense data frames should meet the following relationship:

2≤(Sense(N+1)−Sense(N))≤2+M

Wherein Sense(N+1) is the (N+1)^{th} sense data frame, and Sense(N) is the N^{th} sense data frame, and N is larger than or equal to 1, and M is the times by which the frame rate of the display data is increased.

In one embodiment, the number of the cyclic frames is four, which means the frame rate of the display data is increased by four times. The relationship between the positions of the adjacent two sense data frames should meet the following relationship:

2≤(Sense(N+1)−Sense(N))≤6

Wherein, Sense(N+1) is the (N+1)^{th} sense data frame, and Sense(N) is the N^{th} sense data frame, and N is larger than or equal to 1.

As shown in FIG. 2, which is a schematic diagram of the driving method for the display panel real-time sense in the disclosure. As shown in FIG. 2, the frame rate of the display data of which the frame rate is increased is four times of the frame rate of the original display data. After the frame rate is increased, the first frame of the original data frames is duplicated as the first frame, the second frame, the third frame, and the fourth frame, and the second frame of the original data frames is duplicated as the fifth frame, the sixth frame, the seventh frame, and the eighth frame. The first frame through the fourth frame cyclically displays the data 1, and the fifth frame through the eighth frame cyclically display the data 2. The fourth frame is selected from the first cyclic frames as the first sense data frame, and the sixth frame is selected from the second cyclic frames as the second sense data frame. The first sense data frame and the second sense data frame are the adjacent two sense data frames, and a non-sense data frame, the fifth frame, is therebetween. In another embodiment, the first sense data frame and the second sense data adjacent to the first sense data frame are respectively, for example, the first frame and the fifth frame, or the second frame and the fifth frame, or the first frame and the sixth frame.

In another embodiment, as shown in FIG. 3, which is a schematic diagram of the display panel driving method with real-time sense in another embodiment of the disclosure. As shown in FIG. 3, the frame rate of the display data of which the frame rate is increased is four times of the frame rate of the original display data. After the frame rate is increased, the first frame of the original data frames is duplicated as the first frame, the second frame, the third frame, and the fourth frame, and the second frame of the original data frames is duplicated as the fifth frame, the sixth frame, the seventh frame, and the eighth frame. The first frame through the fourth frame cyclically displays the data 1, and the fifth frame through the eighth frame cyclically displays the data 2. The third frame is selected from the first cyclic frames as the first sense data frame, and the sixth frame is selected from the second cyclic frames as the second sense data frame. The first sense data frame and the second sense data frame are the adjacent two sense data frames, and two non-sense data frame, the fourth frame and the fifth frame, are therebetween. The two non-sense data frames are in adjacent display data, respectively.

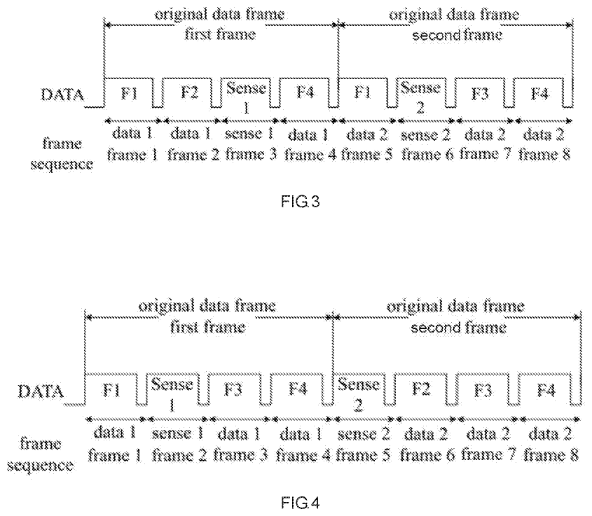

In another embodiment, as shown in FIG. 4, which is a schematic diagram of the display panel driving method with real-time sense in yet another embodiment of the disclosure. As shown in FIG. 4, the frame rate of the display data of which the frame rate is increased is four times of the frame rate of the original display data. After the frame rate is increased, the first frame of the original data frames is duplicated as the first frame, the second frame, the third frame, and the fourth frame, and the second frame of the original data frames is duplicated as the fifth frame, the sixth frame, the seventh frame, and the eighth frame. The first frame through the fourth frame cyclically display the data 1, and the fifth frame through the eighth frame cyclically display the data 2. The second frame is selected from the first cyclic frames as the first sense data frame, and the fifth frame is selected from the second cyclic frames as the second sense data frame. The first sense data frame and the second sense data frame are the adjacent two sense data frames, and two non-sense data frame, the third frame and the fourth frame, are therebetween. The two non-sense data frames are in the same display data.

In advance, there is at least one non-sense data frame between any two sense data frames. Because the sense data frames refer to the black screen, the vision effect is strictly influenced if there are a plurality of black screens successively.

S103: performing a smoothing transition process on the adjacent two sense data frames.

Practically, the smoothing transition process is performed on the adjacent two sense data frames with the image smoothing algorithm so as to make the black screens smooth and not to influence the vision effect. The image smoothing algorithm includes interpolation, linear smoothing, convolution, etc.

Distinguished from the conventional technique, the disclosure provides a display panel driving method with real-time sense different from the conventional sense method by increasing the frame rate of the display data in the display panel so as to obtain the cyclic frames of the display data. Then, one among the cyclic frames is selected as the sense data frame, so the higher resolution is supported and the time for sensing data is delayed. The disclosure increases the time for sensing and lower the requirement of sensing while keeping the timely and accurate sensing effect. Besides, by the post-sensing smoothing algorithm, the black screens due to the sensing are reduced.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A display panel driving method with real-time sense, wherein the driving method comprises:
increasing a frame rate of display data in the display panel to obtain cyclic frames of the display data;
taking any one among the cyclic frames as a sense data frame, wherein there is at least one non-sense data frame between adjacent two sense data frames; and
performing a smoothing transition process on the adjacent two sense data frames with an image smoothing algorithm.

2. The display panel driving method according to claim 1, wherein there are at least two non-sense data frames between the adjacent two sense data frames, and the at least two non-sense data frames are in the same display data.

3. The display panel driving method according to claim 1, wherein there are at least two non-sense data frames between the adjacent two sense data frames, and the at least two non-sense data frames are in adjacent display data.

4. The display panel driving method according to claim 1, wherein the step of increasing the frame rate of the display data in the display panel to obtain the cyclic frames of the display data comprises: increasing the frame rate of the display data in the display panel by M times to obtain M cyclic frames of the display data.

5. The display panel driving method according to claim 4, wherein the step of increasing the frame rate of the display data in the display panel to obtain the cyclic frames of the display data comprises: increasing the frame rate of the display data in the display panel by four times to obtain four cyclic frames of the display data.

6. The display panel driving method according to claim 5, wherein a relationship between positions of the adjacent two sense data frames meets:
2≤(Sense(N+1)−Sense(N))≤6;
wherein Sense(N+1) is the (N+1)^{th} sense data frame and Sense(N) is the N^{th} sense data frame, and N≥1.

7. The display panel driving method according to claim 1, wherein the display panel is an OLED display panel.

8. A display panel driving method with real-time sense, wherein the driving method comprises:
increasing a frame rate of display data in the display panel to obtain cyclic frames of the display data;
taking any one among the cyclic frames as a sense data frame; and
performing a smoothing transition process on adjacent two sense data frames.

9. The driving method according to claim 8, wherein there is at least one non-sense data frame between adjacent two sense data frames.

10. The driving method according to claim 8, wherein there are at least two non-sense data frames between the adjacent two sense data frames, and the at least two non-sense data frames are in the same display data.

11. The display panel driving method according to claim 8, wherein there are at least two non-sense data frames between the adjacent two sense data frames, and the at least two non-sense data frames are in adjacent display data.

12. The display panel driving method according to claim 8, wherein the step of increasing the frame rate of the display data in the display panel to obtain the cyclic frames of the display data comprises: increasing the frame rate of the display data in the display panel by M times to obtain M cyclic frames of the display data.

13. The display panel driving method according to claim 12, wherein the step of increasing the frame rate of the display data in the display panel to obtain the cyclic frames of the display data comprises: increasing the frame rate of the display data in the display panel by four times to obtain four cyclic frames of the display data.

14. The display panel driving method according to claim 13, wherein a relationship between positions of the adjacent two sense data frames meets:
2≤(Sense(N+1)−Sense(N))≤6;
wherein Sense(N+1) is the (N+1)^{th} sense data frame and Sense(N) is the N^{th} sense data frame, and N≥1.

15. The display panel driving method according to claim 8, wherein the step of performing the smoothing transition process on the adjacent two sense data frames comprises:
performing the smoothing transition process on the adjacent two sense data frames with an image smoothing algorithm.

16. The display panel driving method according to claim 8, wherein the display panel is an OLED display panel.

17. A display device, wherein the display device comprises a display panel and a driving unit, and the driving unit implements the following driving method for real-time sense:
increasing a frame rate of display data in the display panel to obtain cyclic frames of the display data;
taking any one among the cyclic frames as a sense data frame; and
performing a smoothing transition process on adjacent two sense data frames.
